(19) United States
(12) Patent Application Publication
(10) Pub. No.: US 2007/0098485 A1
(43) Pub. Date: May 3, 2007

(54) Discharge structure of the cosmetics brush

(76) Inventor: Young-Kwang Byun, Seoul (KR)

Correspondence Address: BIRCH STEWART KOLASCH & BIRCH, PO BOX 747, FALLS CHURCH, VA, 22040-0747, US

(21) Appl. No.: 11/524,369

(22) Filed: Sep. 21, 2006

(30) Foreign Application Priority Data
Nov. 3, 2005 (KR) 10-2005-0104670

(51) Int. Cl. A47L 13/22; A46B 11/04; B43K 7/12

(52) U.S. Cl. 401/286; 401/282; 401/117

(57) ABSTRACT

A discharge structure of the cosmetic brush, and more particularly, to a discharge structure of the cosmetic brush capable of discharging a constant amount of powder to a brush side, regulating the discharge of powder freely, and refilling powder by separating an inner moving body. As an inner moving body is pushed to the brush side, a conical elastic part, forming a coupler coupled by screws to the upper part of the inner moving body, is compressed, and at the same time, a vertical pole moves to the central part of the inner moving body, so as the inner hole is opened, a constant amount of powder is discharged to the brush side through the penetrating hole, the inner hole and the powder transporting tube. And as the inner moving body is pushed, the inner moving body descends and returns by the expansive force of the conical elastic part and the elastic force of the spring, thread formed to the lower circumference of the vertical pole. Then the inner hole is closed by the sealing ring, formed to the circumference of the vertical pole, and the powder is prevented from being discharged. So the discharge of the powder can be easily controlled semi-automatically by the conical elastic part, formed at the coupler, and the spring. And because the assembling and disassembling of the coupler of the inner moving body are easy, the inner moving body can be opened for refilling powder when powder is used up.

### CROSS-REFERENCE TO RELATED APPLICATIONS

This application claims the benefit of Korean Patent Application No. 10-2005-0104670, filed on Nov.3, 2005, in the Korean Intellectual Property Office, the disclosure of which is incorporated herein by reference.

### BACKGROUND

1. Field of the Invention

The present invention relates to a discharge structure of the cosmetic brush, and more particularly, to a discharge structure of the cosmetic brush capable of discharging a constant amount of powder to a brush side, regulating the discharge of powder freely, and refilling powder by separating an inner moving body.

As an inner moving body is pushed to the brush side, a conical elastic part, forming a coupler coupled by screws to the upper part of the inner moving body, is compressed, and at the same time, a vertical pole moves to the central part of the inner moving body, so as the inner hole is opened, a constant amount of powder is discharged to the brush side through the penetrating hole, the inner hole and the powder transporting tube.

As the inner moving body is pushed, the inner moving body descends and returns by the expansive force of the conical elastic part and the elastic force of the spring, thread formed to the lower circumference of the vertical pole. Then the inner hole is closed by the sealing ring, formed to the circumference of the vertical pole, and the powder is prevented from being discharged. So the discharge of the powder can be easily controlled semi-automatically by the conical elastic part, formed at the coupler, and the spring.

Also, because the assembling and disassembling of the coupler of the inner moving body are easy, the inner moving body can be opened for refilling powder when powder is used up.

2. Discussion of Related Art

Generally speaking, cosmetics are divided into solid state or liquid and the combined liquid state cosmetics. And recently, some cosmetics like lipsticks or foundation are supplied as liquid, and the liquid is usually contained in the pencil-shaped container. And when a part of the container is rotated, the cosmetics in the container are discharged to the upper brush so that a user can apply make-up. And various types of structures have been suggested and used.

The conventional cosmetics brush was separately stored with powder, so carrying and keeping them were not easy.

However, recently, powder is contained in the container-shaped body, and the powder is discharged to the brush side by the air pressure. And various types have been suggested and used. And it was disclosed in Utility Model No. 0253672, and FIG. 11 and FIG. 12 show the constitution. [0008] As illustrated in FIG. 11 and FIG. 12, it is composed of the first body 102 where cosmetics powder 103 is contained as the upper and the lower parts are in the opened pipe type; the second body 106 where it is coupled at the circumference of the lower side of the first body 102, a discharge hole 107 is formed at the central part of the upper side, and a brush 108 connected with the discharge hole 107 is equipped; a vertical transfer axis 109 where a spring 110 is coupled at the circumference of the front end, the front end is coupled with the discharge hole 107 of the second body 106, and the spring 110 is supported at the front end circumference of the discharge hole 107; the upper cap 113 that supports as it makes the front end part of the vertical transfer axis 109 protruded by being coupled at the front end of the first body 102.

According the constitution like the above, when a user applies make-up using the cosmetics brush, the user uses the brush by pressing the button 102 protruded to the upper side by being coupled at the front end of upper and lower transfer axes 109. At this point, the transfer axis 109 moves vertically by the spring 100 at the front end of the transfer axis 109. And as the transfer axis 109 moves vertically, the power 103 contained inside the body 102 is supplied to the outside, that is, the brush 108 through the discharge hole 107 where the front end of the transfer axis 109 is formed at the second body 106 for convenient use.

At this point, the cosmetics powder discharged to the brush through the discharge hole 107 is supplied to the brush 108, as the end front of the transfer axis 109 directly penetrates the discharge hole 107.

However, in case of the conventional cosmetics brush like the above, powder 013 is discharged to the brush 108 by the front end part of the transfer axis 109. It not only cannot discharge power constantly because of the structure of the transfer axis 109, but also makes a user inconvenient because the powder 103 is discharge to the brush 108 side only because of the shaking of the brush.

Also, the button 112 formed at the upper cap 113 side is always in the protruded state to the outer side by the elasticity of the spring 110. So if it is bumped into any hand baggage while a user carries it or it is given any external force, the button 112 can be moved, then the power 103 can be unnecessarily discharged to the brush 108, damaging other belongings. And also, when it is stored in a wet place or it is not used for a long time, the discharge becomes difficult because the powder 103 contained inside the first body 102 and the power remaining in the discharge hole 107 are hardened.

### SUMMARY OF THE INVENTION

In order to solve the above-described problems, it is an object of the present invention to provide a discharge structure of the cosmetic brush capable of discharging a constant amount of powder to a brush side, regulating the discharge of powder freely, and refilling powder by separating an inner moving body when powder is used up.

In order to achieve the foregoing and/or other objects of the present invention, according to a first aspect of the present invention, as an inner moving body is pushed to the brush side, a conical elastic part, forming a coupler coupled by screws to the upper part of the inner moving body, is compressed, and at the same time, a vertical pole moves to the central part of the inner moving body, so as the inner hole is opened, a constant amount of powder is discharged to the brush side through the penetrating hole, the inner hole and the powder transporting tube.

According to a second aspect of the present invention, as the inner moving body is pushed, the conical elastic part is compressed, then the inner hole is opened, then the powder is discharged to the brush side. At the same time, the inner moving body descends and returns by the expansive force of the conical elastic part and the elastic force of the spring, thread formed to the lower circumference of the vertical pole. Then the inner hole is closed by the sealing ring, formed to the circumference of the vertical pole, and the powder is prevented from being discharged. So the discharge of the powder can be easily controlled semi-automatically by the conical elastic part, formed at the coupler, and the spring. And because the assembling and disassembling of the coupler of the inner moving body are easy, the inner moving body can be opened for refilling powder when powder is used up.

### BRIEF DESCRIPTION OF THE DRAWINGS

These and/or other objects and advantages of the invention will become apparent and more readily appreciated from the following description of preferred embodiments, taken in conjunction with the accompanying drawings of which:

FIG. 1 is a perspective view of the present invention in the state the cap is opened;

FIG. 2 is an exploded perspective view of the present invention;

FIG. 3 is a sectional view of the present invention;

FIG. 4 is a sectional view of the present invention at the state the inner moving body is pushed up;

FIG. 5 is a sectional view of the first embodiment according to the present invention;

FIG. 6 is a sectional view of the first embodiment according to the present invention at the state the inner moving body is pushed up;

FIG. 7 is a sectional view of the second embodiment according to the present invention;

FIG. 8 is a sectional view of the second embodiment according to the present invention at the state the inner moving body is pushed up;

FIG. 9 is a sectional view of the third embodiment according to the present invention;

FIG. 10 is a sectional view of the third embodiment according to the present invention at the state the inner moving body is pushed up;

FIG. 11 is an exploded perspective view of a conventional product;

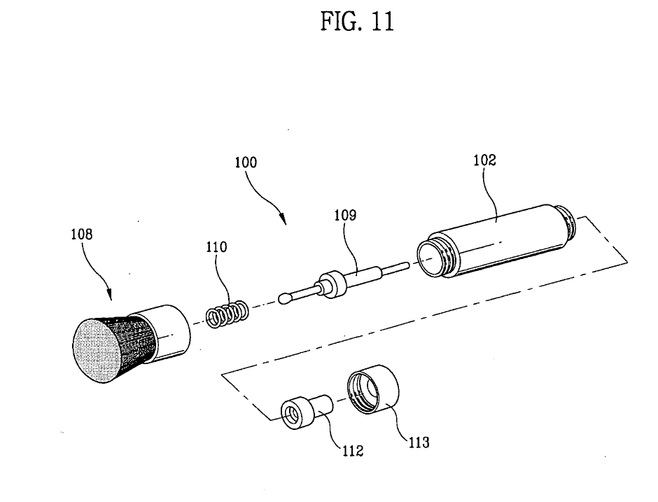

FIG. 12 is a sectional view of a conventional product.

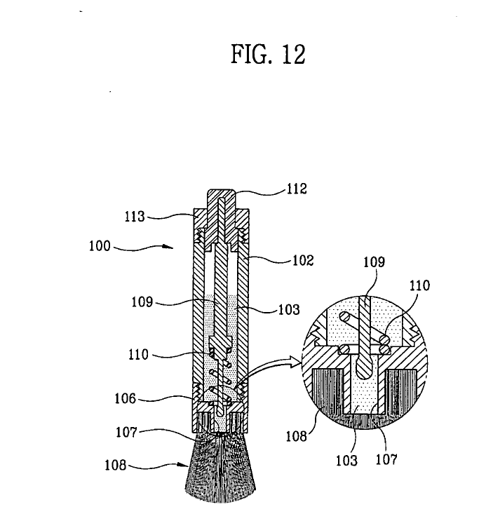

### DETAILED DESCRIPTION OF PREFERRED EMBODIMENTS

Hereinafter, preferred embodiments of the present invention will be described with reference to the accompanying drawings.

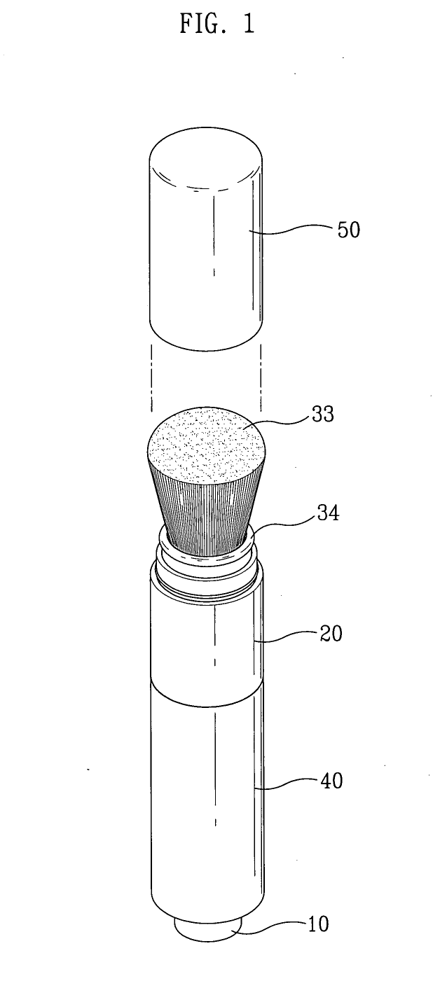

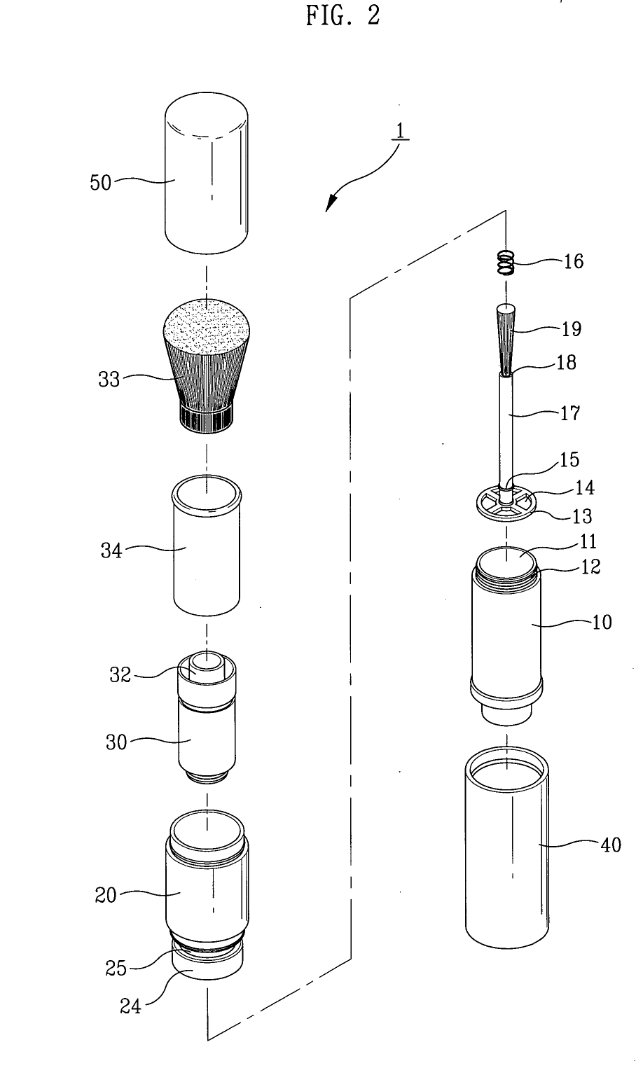

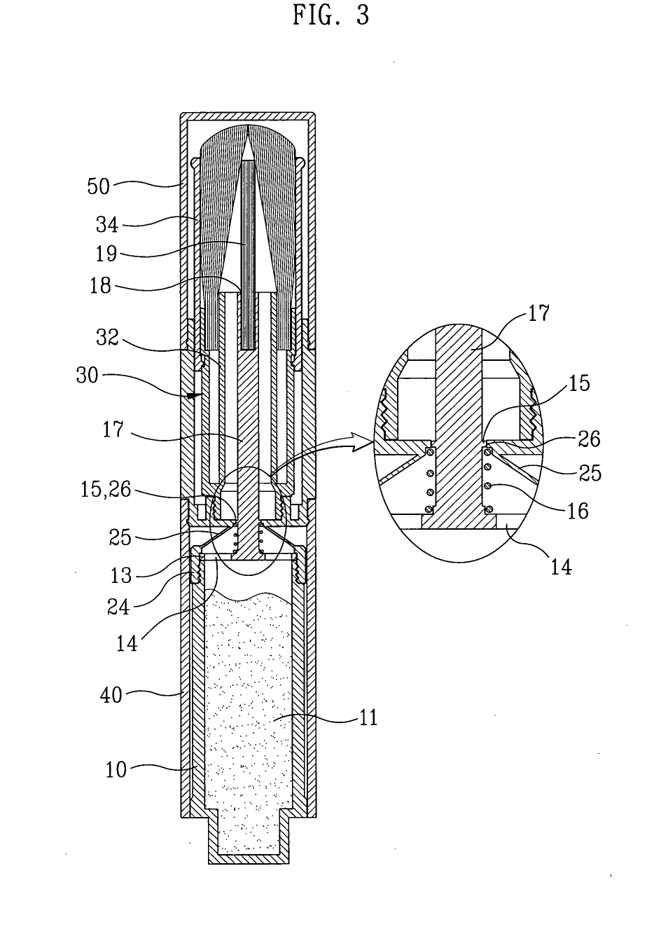

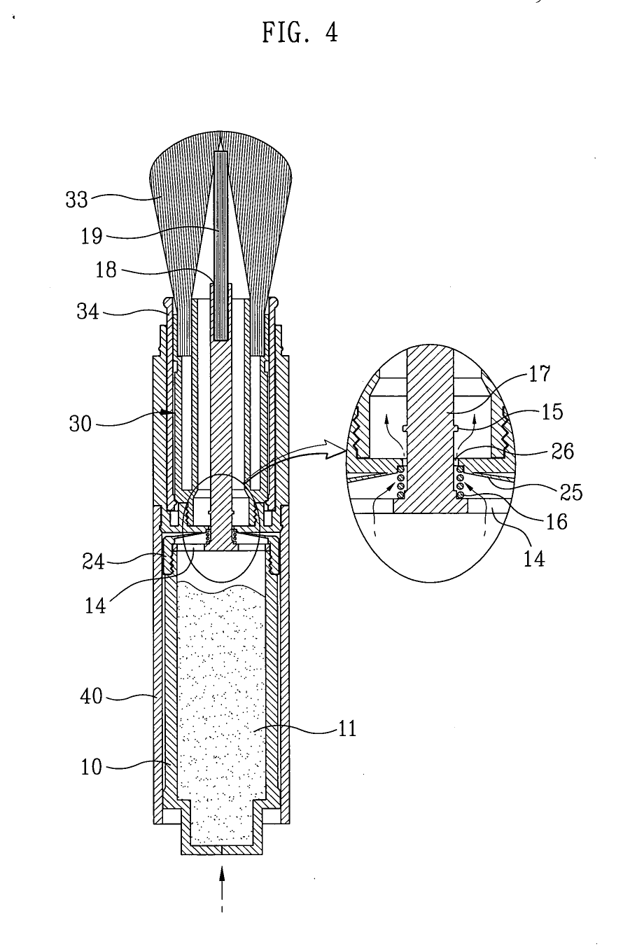

FIG. 1 is a perspective view of the present invention in the state the cap is opened, FIG. 2 is an exploded perspective view of the present invention, FIG. 3 is a sectional view of the present invention, and FIG. 4 is a sectional view of the present invention at the state the inner moving body is pushed up.

The present invention is composed of a inner moving body 10 where a sealing ring 15, in which a spring 16 is interposed to the upper part of a support 13 in which a penetration hole 14 is formed, is formed, and a vertical pole 17, in which a thread groove 18 is formed, is put in;

an outer upper moving body 20 where it is coupled to the upper part of the inner moving body by a coupler 24, a conical elastic part 25 is connected to the upper part of the coupler 24, and the vertical pole 17 is thread coupled to the inner hole 26 formed to the central part;

an inner upper moving body 30 where it is equipped with a powder transporting tube 32 to the inside, a brush 33 is thread coupled to the upper side, a brush cover 34 is formed to the outside, and it is coupled to the inside of the outer upper moving body 20;

Where the outer lower moving body 40 is thread coupled to the lower circumference of the outer upper moving body 20, and a cap 50 is coupled to the upper side.

As the inner moving body is pushed, a conical elastic part 25 is compressed, and an inner hole 26 is opened. Then not only powder is discharged to the brush side 33, but also the inner moving body 10 descends and returns by the expansive force of the conical elastic part 25 and the elastic force of the spring 16 thread formed to the lower circumference of a vertical pole 17. Then the inner hole 26 is closed by the sealing ring 15 formed at the circumference of the vertical pole 17 so that the power is discharged. So it is possible to freely regulate the discharge of the power semi-automatically by the conical elastic part 25 and the spring 16 formed at the coupler 24.

And the accompanying drawings can be described in details as follows.

As described at FIG. 1 to FIG. 4, the present invention includes a container 11 containing powder to the inside of the inner moving body 10, and an outer screw part 12 at the outer upper circumference.

An inner hole 26 is formed at the central part to the outer screw part 12 formed to the inner moving body 10, and the outer upper moving body 20 is screw coupled as the coupler formed by the conical elastic part to the lower part.

A support 13, where a penetrating hole 14 is formed between the upper part of the inner moving body 10 and the coupler 24, is coupled, and the vertical pole 17 is thread coupled by penetrating the inner hole 26.

At this point, the sealing ring 15, where the spring 16 is interposed to the lower circumference of the vertical pole 17, seals by being positioned at the inner hole 26, as described at FIG. 3, and the above spring 16 keeps pushing the inner moving body 10 by the elastic force by being supported at the lower part of the inner hole 26.

On the other hand, the inner upper moving body 30 is thread coupled to the inside of the outer upper moving body 20, the inner upper moving body is equipped with the powder transporting tube 32, the brush 33 is thread coupled, and the brush cover 34, which gathers the brush 33 as it slides at the outer side, is coupled.

The outer lower moving body 40 is thread coupled to the lower circumference of the outer upper moving body 20, and the inner moving body 10 is located to the inner side of the outer lower moving body 20.

And the cap 50 is thread coupled to the upper circumference of the outer upper moving body 20. In this way, the cosmetics brush 1 is constituted.

The effects by the present invention can be explained as follows.

As described at FIG. 3, the cosmetics brush 1 of the present invention is in the state that the force is not given to the lower part of the inner moving body in the normal situation 20, so the inner moving body 10, where the coupler 24, formed to the lower part of the outer upper moving body 20, is thread coupled, is in the descended state, and the cap 50 is coupled to the upper side, and it is in the closed state.

So the support 13, where the penetrating hole 14 is formed to the lower part of the vertical pole 17 between the upper part of the inner moving body 10 and the coupler 24, is in the coupled state. And the vertical pole 17 is in the state where it is located at the inner part of the powder transporting tube 32 formed to the inside of the inner upper moving body 30 by penetrating the inner hole 26 formed to the inner central side of the outer upper moving body 20.

At this point, the sealing ring 15, formed to the lower part of the vertical pole 17, is in the same state with the inner hole 26, and the sealing ring 15 is closing the inner hole 26.

Also, the auxiliary brush 19 is thread coupled to the thread groove 18 formed to the upper part of the vertical pole 17.

Like the above, if the lower part of the inner moving body 10 is pressed in the state that the inner hole 26 is sealed by the sealing ring 15 of the vertical pole 17, the conical elastic part 25, formed to the lower part of the coupler 24, is compressed, and the inner moving body 10 ascends to the inner part of the outer lower moving body 40.

Therefore, as described at FIG. 4, as the inner moving body 10 ascends, the sealing ring, which was sealing the inner hole 26 by being formed to the lower circumference of the vertical pole 17, deviates from the inner hole 26, and the inner hole 26 is opened. And the spring interposed to the lower part of the vertical pole 17 comes to the compressed state.

So, in the state the inner hole 26 is opened, as a user applies make-up, gripping the cosmetics brush 1 upside down, the powder contained in the container 11 of the inner moving body 10 is discharged to the brush side through the penetrating hole 14, the inner hole 26 and the powder transporting tube 32, so a user can apply make-up.

Therefore, after the make-up is finished, when the force pressing the inner moving body is released, as the conical elastic part 25 formed to the upper part of the coupler 24 is expanded, the inner moving body 10 descends. Then the sealing ring of the vertical pole 17 also descends, and closes the inner hole 26. In this way, the powder is prevented from being discharged to the brush 33 side, and the powder does not leak when it is not used.

On the other hand, the spring 16, interposed at the lower part of the above vertical pole 17, helps the inner moving body 10 to descend as the conical elastic part 25 is expanded, so helps the inner moving body 10 to easily return to the original state.

Therefore, when a user presses the inner moving body 10, the inner hole 26 is opened, so the powder is easily discharged, and when the force to the inner moving body 10 is released, the inner hole 26 is easily closed.

Also, the inner moving body 10 and the coupler 24 are coupled by screws, so the assembling and disassembling are easy. So when the powder contained in the inner moving body is used up, it can be refilled by opening the inner moving body 10.

In the drawing of the invention, it is described that the brush 33 part is directing to the upside for convenience. But in the real use, a user uses in the state that the brush 3 part is directing to the downside.

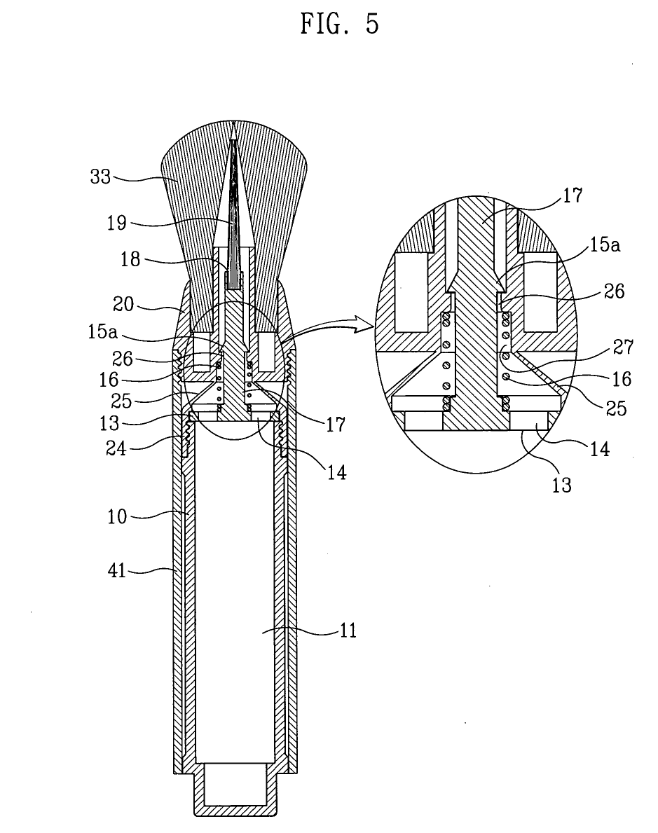

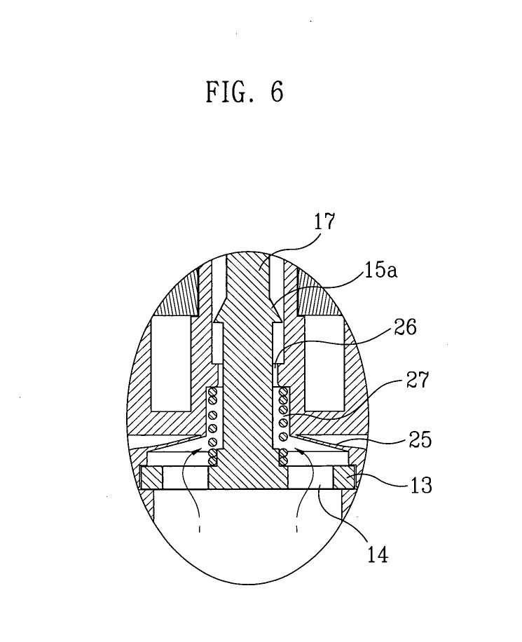

FIG. 5 is a sectional view of the first embodiment according to the present invention, and FIG. 6 is a sectional view of the first embodiment according to the present invention at the state the inner moving body is pushed up.

The inner groove 27, where the inner hole 26 is formed to the inner central part of the outer upper moving body 20, is formed. And the vertical pole 17, where the sealing step wheel 15a is formed to the circumference by penetrating the inner hole 26, is thread coupled. In this way, the cosmetics brush 1a is discharged.

As the inner moving body 10 is pushed to the upper part, as described at FIG. 6, the sealing step wheel 15a, formed to the circumference of the vertical pole 17 sealing the inner hole 26, descends, and the inner hole 26 is opened. The spring 16 supported at the inner groove 27 goes to the compressed state.

So the powder, contained at the container 11 of the inner moving body 10 through the inner hole 26 opened by the deviation of the sealing step wheel 15a, is transported to the powder transporting tube 32 through the inner hole 26 after passing by the penetrating hole 14, and is discharged to the brush 33 side.

Also, the inner moving body 10 is coupled with the coupler 24 by screws. And because the assembling and the disassembling are easy, it can be easily refilled when the powder contained in the inner moving body 10 is used up.

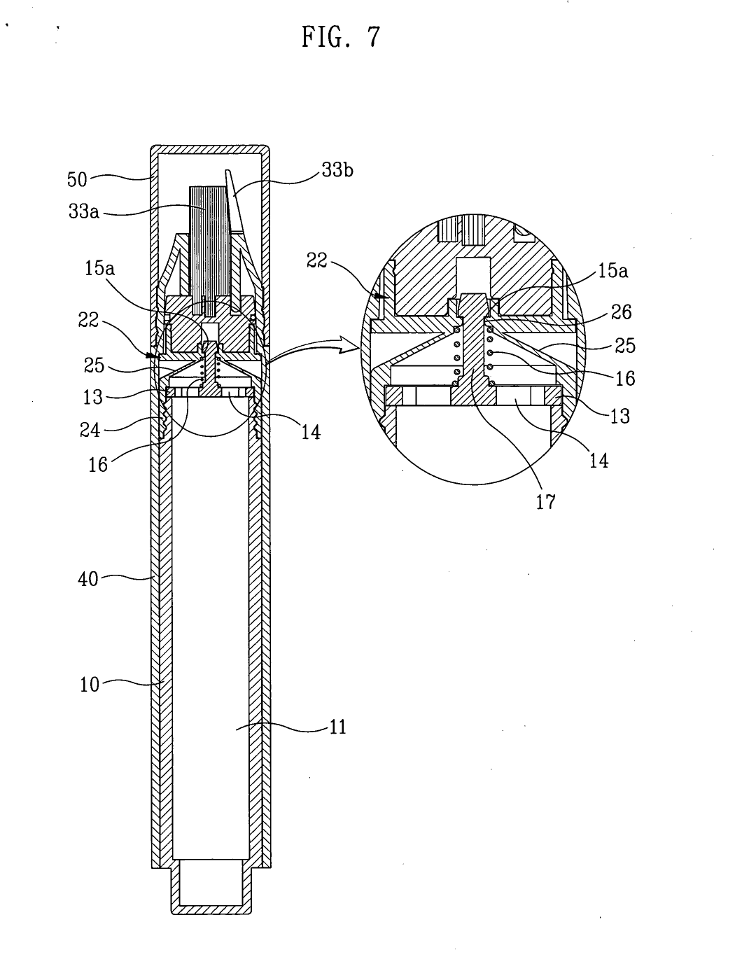

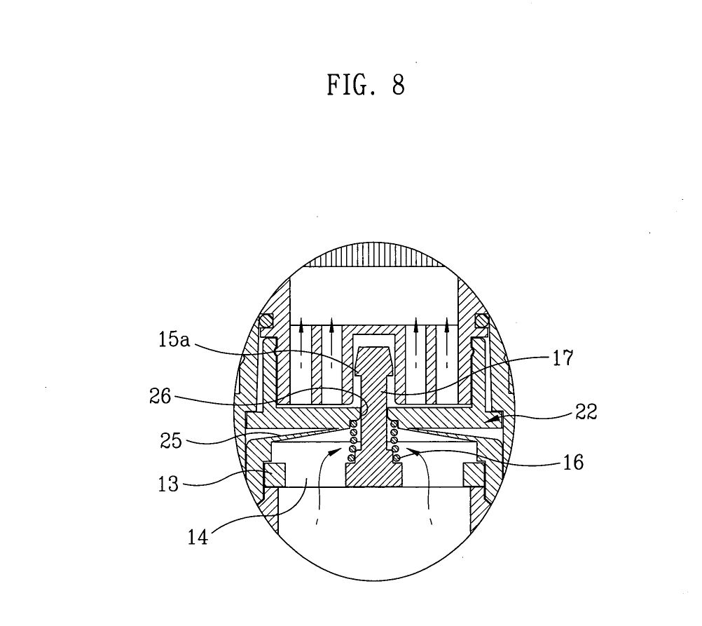

FIG. 7 is a sectional view of the second embodiment according to the present invention, and FIG. 8 is a sectional view of the second embodiment according to the present invention at the state the inner moving body is pushed up.

The discharge structure of the cosmetics brush 1b contains liquid cosmetics. As the inner moving body 10 is pushed to the upper part, the inner hole 26 is opened as the sealing step wheel, formed to the upper part of the vertical pole 17 sealing the upper part of the inner hole 26, descends, and the inner hole 26 is opened. And the spring goes to the compressed state.

So as the sealing step wheel 15a is deviated, liquid cosmetics(For example, a hair dye) contained the container 11 of the inner moving body 10 pass by the penetrating hole 14, and are discharged to the hair brush 33a side through the inner hole 26. So a user can apply a hair dye, using the hair brush 33a and the teeth of a comb 33a.

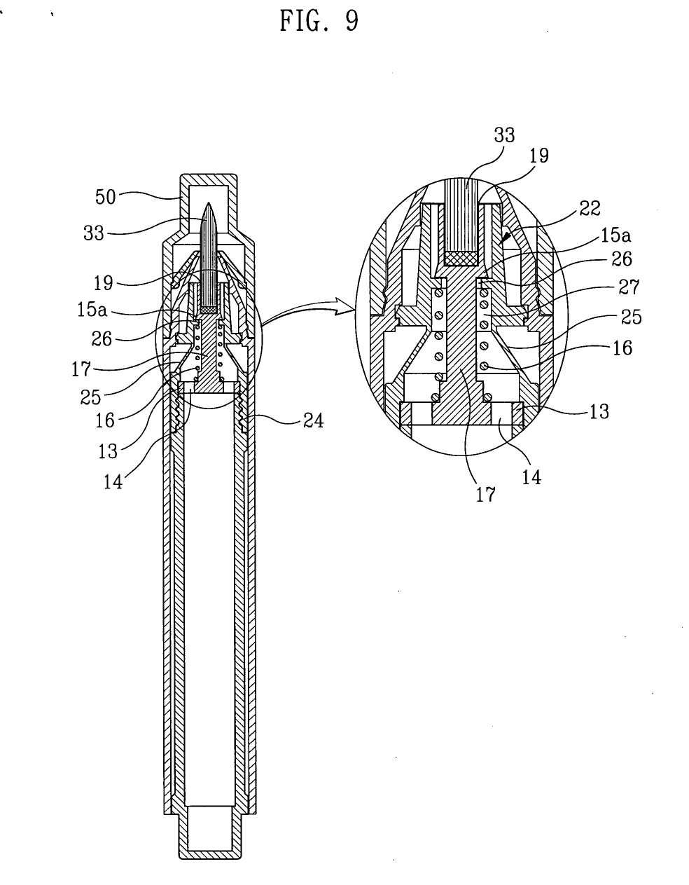

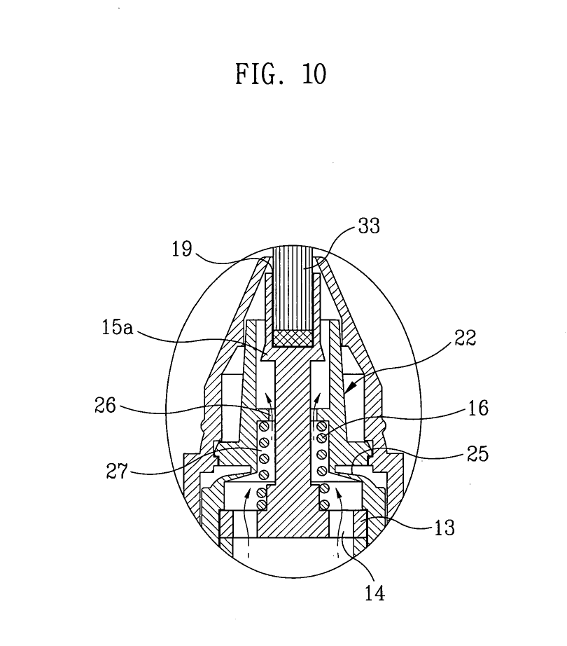

FIG. 9 is a sectional view of the third embodiment according to the present invention, and FIG. 10 is a sectional view of the third embodiment according to the present invention at the state the inner moving body is pushed up.

As described at the second embodiment, the discharge structure of the cosmetics brush 1c uses liquid cosmetics by containing liquid cosmetics. And as the inner moving body 10 is pushed to the upper side, as described at FIG. 10, the sealing step wheel 15a, formed to the upper part of the vertical pole 17 sealing the upper side of the inner hole 26, descends, and the inner hole 26 is opened. And liquid cosmetics(For examples, liquid cosmetics for eyeliners or nail coloring), contained in the containing part 11 of the inner 10 through the opened inner hole 26, are discharged to the brush 33 part through the inner hole 26.

Therefore, cosmetics brushes 1a 1b 1c of the first, the second and the third embodiments show the same effects with the cosmetics brush 1 of the present invention.

What is claimed is:

1. A discharge structure of the cosmetics brush, which is featured by the constitution comprising:
an inner moving body in which a sealing ring is interposed to the upper part of a support, where a penetrating hole is formed, and a vertical pole, where a thread groove is formed to the upper part, is located;
an outer upper moving body wherein it is thread coupled by a coupler to the upper part of the inner moving body, it is connected as a conical elastic part to the upper part of the coupler, and the vertical pole is thread coupled to the inner hole formed to the central part;
an inner moving body wherein it is equipped with a powder transporting tube to the inside, a brush is thread coupled to the upside, a brush cover is formed to the outside, and it is coupled to the inside of the outer upper moving body;
an outer lower moving body, thread coupled to the lower circumference of the outer upper moving body; and
a cap, thread coupled to the upper side.

2. The discharge structure of cosmetics brush as claimed in claim 1,
wherein an inner groove, where an inner hole is formed to the inner central part of the outer upper moving body, is formed, and a vertical pole, where a sealing step wheel is formed to the circumference by penetrating the inner hole, is thread coupled.

3. The discharge structure of cosmetics brush as claimed in claim 1,
wherein
an inner moving body having a container containing a liquid hair dye; and
an outer moving body, in which a support equipped with a vertical pole having a sealing step wheel at the upper side of the inner moving body, is coupled, the vertical pole is thread coupled with an inner hole, and it is equipped with a hair brush and the teeth of a comb;
are thread coupled.

4. The discharge structure of cosmetics brush as claimed in claim 1,
wherein a middle support and a brush are equipped at the upper part of the inner moving body, a vertical pole having the sealing step wheel is thread coupled, and it is thread coupled to the outer moving body where an upper thread part is formed.
